(19) United States
(12) Patent Application Publication
(10) Pub. No.: US 2023/0245239 A1
(43) Pub. Date: Aug. 3, 2023

(54) SYSTEMS AND METHODS FOR MODELING ITEM DAMAGE SEVERITY

(71) Applicant: Allstate Insurance Company, Northbrook, IL (US)

(72) Inventor: Laura Collins, Northbrook, IL (US)

(73) Assignee: Allstate Insurance Company, Northbrook, IL (US)

(21) Appl. No.: 17/587,807

(22) Filed: Jan. 28, 2022

(51) Int. Cl. G06Q 40/08; G06N 20/00; G06K 9/62

(52) U.S. Cl. CPC G06Q 40/08; G06N 20/00; G06K 9/6253

(57) ABSTRACT

Systems and methods for explaining year over year changes in claim variables are provided. A computing system is configured to receive claim datasets corresponding to one or more time periods, and parse a plurality of claim variables from each claim dataset. The computing system is also configured to cause one or more machine learning models to parse a plurality of explainer values from each of the claim datasets, determine an average explainer value for each of the plurality of explainer values, and determine percent impact values that each correspond to a particular claim variable. The computing system is also configured to generate and render a user interface having one or more selectable features that each represent one of the percent impact values. The computing system is also configured to filter and sort the one or more selectable features based on the percent impact values.

### TECHNICAL FIELD

The present disclosure relates generally to systems and methods for modeling item damage severity for an insured item. Insured items may include a variety of tangible items, such as vehicles, boats, houses, household items, etc. As utilized herein, the terms “severity”, “item damage severity”, and other similar terms may refer to a quantitative or qualitative description of damage to an item, a quantitative value of damage relative to a baseline value, a dollar amount needed to repair/replace damaged items, a qualitative descriptor, and/or other descriptors related to the magnitude of item damage. The terms “item” and “insured item” are used interchangeably.

### BACKGROUND

Insurance claims are provided to insurance providers to receive insurance benefits, such as payouts, when an insured item is lost or damaged. Insurance providers may analyze insurance claims in order to determine item damage severity and the associated expected payout amount in a given time period. However, analyzing large amounts of insurance data, such as claims where each claim has multiple variables impacting the item damage severity, may be time consuming and inaccurate.

### SUMMARY

At least one embodiment relates to a provider computing system. The provider computing system includes a communication interface structured to communicatively couple the provider computing system to a network. The provider computing system also includes a claims database storing claims information for a plurality of claims. The claims information includes a plurality of claim variables. The provider computing system also includes an item damage severity database storing severity information. The provider computing system also includes an item damage severity modeling circuit storing computer-executable instructions embodying one or more machine learning models. The provider computing system also includes at least one processor and memory storing instructions that, when executed by the at least one processor, cause the at least one processor to: receive a first claim dataset corresponding to a first time period; parse a first plurality of variables from the first claim dataset; receive a second claim dataset corresponding to a second time period before the first time period; parse a second plurality of variables from the second claim dataset; cause, by the item damage severity modeling circuit, the one or more machine learning models to parse a first plurality of explainer values from the first claim dataset and a second plurality of explainer values from the second claim dataset; determine a first plurality of average explainer values for each of the first plurality of explainer values and a second plurality of average explainer values for each of the second plurality of explainer values; determine percent impact values, wherein each of the percent impact values correspond to a first claim variable of the first plurality of variables and a second claim variable of the second plurality of variables, and wherein the first claim variable corresponds to the second claim variable; generate and render, via a display of a computing device, a damage severity user interface comprising one or more selectable features, the one or more selectable features each representing one of the percent impact values; and filter and sort the one or more selectable features based on the percent impact values and a predetermined impact threshold such that the one or more selectable features representing the percent impact values that are above the predetermined impact threshold are ordered from left to right in descending order.

Another embodiment relates to a method. The method includes communicatively coupling, by a communication interface, a provider computing system to a network. The method also includes storing, by a claims database, claims information for a plurality of claims. The claims information includes a plurality of claim variables. The method also includes storing, by an item damage severity database, severity information. The method also includes storing, by an item damage severity modeling circuit, computer-executable instructions embodying one or more machine learning models. The method also includes receiving a first claim dataset corresponding to a first time period. The method also includes parsing a first plurality of variables from the first claim dataset. The method also includes receiving a second claim dataset corresponding to a second time period before the first time period. The method also includes parsing a second plurality of variables from the second claim dataset. The method also includes causing, by an item damage severity modeling circuit of the provider computing system, the one or more machine learning models to parse a first plurality of explainer values from the first claim dataset and a second plurality of explainer values from the second claim dataset. The method also includes determining a first plurality of average explainer values for each of the first plurality of explainer values and a second plurality of average explainer values for each of the second plurality of explainer values. The method also includes determining percent impact values, wherein each of the percent impact values correspond to a first claim variable of the first plurality of variables and a second claim variable of the second plurality of variables, and wherein the first claim variable corresponds to the second claim variable. The method also includes generating and rendering, via a display of a computing device, a damage severity user interface comprising one or more selectable features, the one or more selectable features each representing one of the percent impact values. The method also includes filtering and sorting the one or more selectable features based on the percent impact values and a predetermined impact threshold such that the one or more selectable features representing the percent impact values that are above the predetermined impact threshold are ordered from left to right in descending order.

Another embodiment relates to non-transitory computer readable media having computer executable instructions embodied therein that, when executed by at least one processor of a computing system, cause the computing system to perform operations for generating multi-variable severity values. The operations include communicatively couple, by a communication interface, to a network. The operations also include store, by a claims database, claims information for a plurality of claims. The claims information includes a plurality of claim variables. The operations also include store, by an item damage severity database, severity information. The operations also include store, by an item damage severity modeling circuit, computer-executable instructions embodying one or more machine learning models. The operations also include receive a first claim dataset corresponding to a first time period. The operations also include parse a first plurality of variables from the first claim dataset. The operations also include receive a second claim dataset corresponding to a second time period before the first time period. The operations also include parse a second plurality of variables from the second claim dataset. The operations also include cause the one or more machine learning models to parse a first plurality of explainer values from the first claim dataset and a second plurality of explainer values from the second claim dataset. The operations also include determine a first plurality of average explainer values for each of the first plurality of explainer values and a second plurality of average explainer values for each of the second plurality of explainer values. The operations also include determine percent impact values. Each of the percent impact values correspond to a first claim variable of the first plurality of variables and a second claim variable of the second plurality of variables, and wherein the first claim variable corresponds to the second claim variable. The operations also include generate and render, via a display of a computing device, a damage severity user interface comprising one or more selectable features, the one or more selectable features each representing one of the percent impact values. The operations also include filter and sort the one or more selectable features based on the percent impact values and a predetermined impact threshold such that the one or more selectable features representing the percent impact values that are above the predetermined impact threshold are ordered from left to right in descending order.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

These and other advantages and features of the systems and methods described herein, together with the organization and manner of operation thereof, will become apparent from the following detailed description when taken in conjunction with the accompanying drawings.

### BRIEF DESCRIPTION OF THE DRAWINGS

FIGS. 1A and 1B are block diagrams of a computing system, according to various example embodiments.

FIG. 2 is a flow diagram including computer-based operations for training a machine learning model.

FIG. 3 is a flow diagram including computer-based operations for determining a multi-variable percent change in item damage severity.

FIG. 4A is an illustration showing various aspects of a user interface, according to an example embodiment.

FIGS. 4B-4D are illustrations showing various aspects of the user interface of FIG. 4A.

FIG. 5 is a component diagram of an example computing system suitable for use in the various embodiments described herein.

### DETAILED DESCRIPTION

Referring generally to the figures, disclosed are systems, methods and non-transitory computer-readable media for a provider computing system for determining item damage severity.

In conventional claims processing systems, item damage severity is determined retroactively—that is, when all factors that impact the item damage severity are fully known. Severity is also conventionally analyzed using a single-variable approach, where the impact of each variable is determined separately from other variables. Conventional severity investigations therefore result in large amounts of data for each individual variable, and, in some instances, may be inaccurate due to the limited single variable scope.

Accordingly, the systems, methods, and computer-executable media described herein provide an improved computing system for determining severity based on a multi-variable approach. The improved computing systems advantageously predict severity based on claims data such that severity for claims from a first time period can be predicted, rather than determined retroactively. Additionally, the systems, methods, and computer-executable media described herein provide an improved user interface that advantageously provides severity data. The improved user interface may reduce the amount of data transmissions necessary for a user to understand a determined severity, for example, by reducing the number of graphics (e.g., graphs, tables, text, etc.) needed to visually represent the determined severity. Further, the improved user interface advantageously filters and sorts the severity data such that relatively more relevant severity data is presented before and/or instead of relatively less relevant severity data. For example, relatively less relevant (e.g., lower magnitude) severity values may be automatically grouped into an “other” category and displayed as a single graphical feature. Thus the improved user interface provides at least one specific improvement over prior systems, for example, by reducing the number of graphical elements needed to understandably convey severity data. Additionally, the systems, methods, and computer-executable media described herein embody a self-correcting predictive system that is periodically re-trained using current data such that the accuracy of predictions for item damage severity is improved over time.

In an example illustrative scenario, a provider (e.g., an insurance provider) receives damage data for an insured item, such as a vehicle, boat, household appliance, home, etc. In some embodiments, the damage data is included, at least in part, in one or more insurance claims. A claim may include first notice of loss (FNOL) and claim data for an insured item or for an item associated with an insured item. The claim data includes one or more claim variables. In some embodiments, a provider computing system may receive some or the entirety of damage data from a telematics device and/or another computing device associated with a customer of the provider, a provider employee, or a provider agent. In some embodiments, the damage data may be received from a claims processing device and/or computing system. The provider computing system may include one or more machine learning models embodied in one or more circuits for analyzing the claims. The provider computing system may parse or otherwise extract the variables that impact item damage severity from the damage data. The provider computing system may determine a severity impact percentage and/or other related information (trending data, absolute values, averages, periodic change, predicted value(s) for subsequent time periods, etc.) for each of the claim variables, and provide a detailed user interface to display these values in a user-interactive format.

The one or more machine learning models may utilize one or more models, frameworks, or other software, programming languages, libraries, etc. In an example embodiment, the one or more machine learning models may utilize a machine learning explanatory model, such as Shapley Additive Explanations (SHAP) to further analyze one or more variables of the one or more machine learning models. Accordingly, the one or more machine learning models may include a machine learning explanatory model, such as SHAP and/or other suitable explanatory model. In an example operating scenario, the one or more machine learning models are trained using claim data and real item damage severity data associated with the claim data. The one or more trained machine learning models receive claim data and output and/or determine an expected severity based on the claim data. The claim data includes one or more claim variables. The one or more machine learning models may utilize SHAP to “explain” (e.g., output and/or determine a quantitative value for) each of the one or more claim variables. Accordingly, the one or more machine learning models may output and/or determine, using SHAP, an item damage severity for each claim variable of each claim. In other example embodiments, the one or more machine learning models may utilize Pandas, XGBoost, and/or other suitable executable code libraries.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

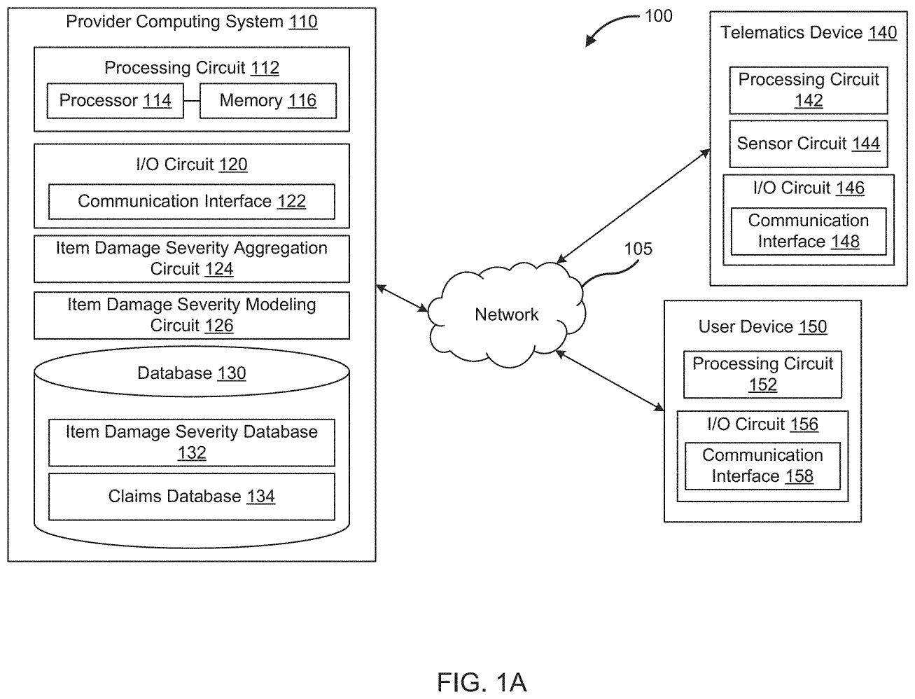

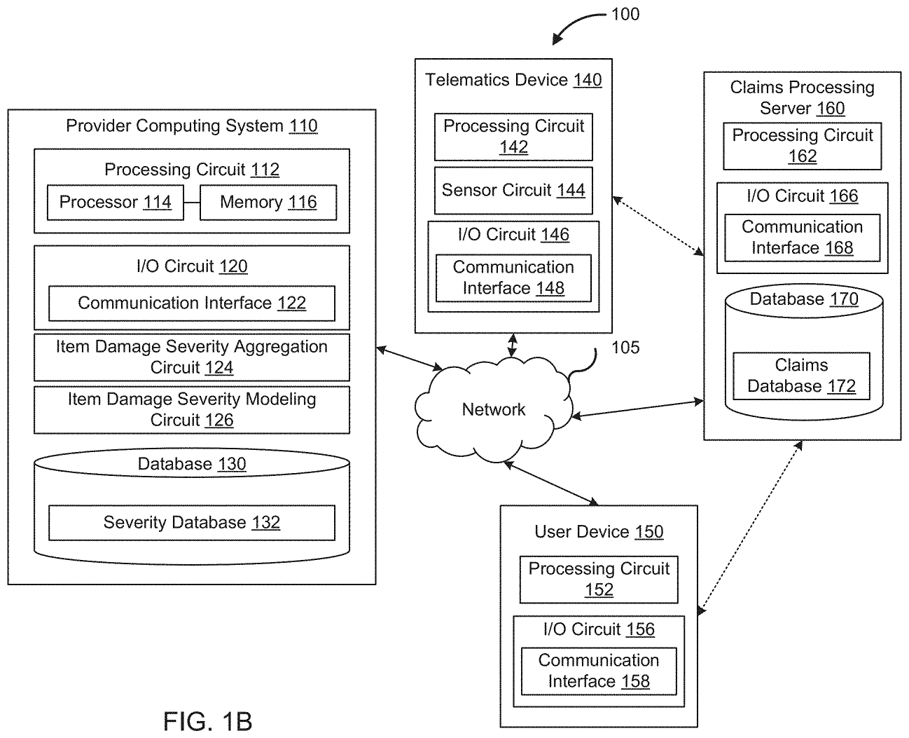

FIGS. 1A and 1B are block diagrams of a computing system 100, according to example embodiments. In some embodiments, the computing system 100 is associated with (e.g., managed and/or operated by) a service provider, such as a business, an insurance provider, and the like. Referring first to FIG. 1A, the computing system 100 includes a provider computing system 110, a telematics device 140, and a user device 150. Each of the computing systems of the computing system 100 are in communication with each other and are connected by a network 105. Specifically, the provider computing system 110, the telematics device 140, and the user device 150 are communicatively coupled to the network 105 such that the network 105 permits the direct or indirect exchange of data, values, instructions, messages, and the like (represented by the double-headed arrows in FIG. 1A). In some embodiments, the network 105 is configured to communicatively couple to additional computing system(s). For example, the network 105 may facilitate communication of data between the provider computing system 110 and other computing systems associated with the service provider or with a customer of the service provider, such as a user device (e.g., a mobile device, smartphone, desktop computer, laptop computer, tablet, or any other computing system). The network 105 may include one or more of a cellular network, the Internet, Wi-Fi, Wi-Max, a proprietary provider network, a proprietary retail or service provider network, and/or any other kind of wireless or wired network.

In some embodiments, the provider computing system 110 may be a local computing system at a business location (e.g., a physical location associated with the service provider). In some embodiments, the provider computing system 110 may be a remote computing system, such as a remote server, a cloud computing system, and the like. In some embodiments, the provider computing system may be part of a larger computing system, such as a multi-purpose server or other multi-purpose computing system. In some embodiments, the provider computing system 110 may be implemented on a third-party computing device operated by a third-party service provider (e.g., AWS, Azure, GCP, and/or other third party computing services).

As shown in FIG. 1, the provider computing system 110 includes a processing circuit 112, input/output (I/O) circuit 120, one or more specialized processing circuits shown as an item damage severity aggregation circuit 124 and item damage severity modeling circuit 126, and a database 130. The processing circuit 112 may be coupled to the I/O circuit 120, the specialized processing circuits, and/or the database 130. The processing circuit 112 may include a processor 114 and a memory 116. The memory 116 may be one or more devices (e.g., RAM, ROM, Flash memory, hard disk storage) for storing data and/or computer code for completing and/or facilitating the various processes described herein. The memory 116 may be or include non-transient volatile memory, non-volatile memory, and non-transitory computer storage media. The memory 116 may include database components, object code components, script components, or any other type of information structure for supporting the various activities and information structures described herein. The memory 116 may be communicatively coupled to the processor 114 and include computer code or instructions for executing one or more processes described herein. The processor 114 may be implemented as one or more application specific integrated circuits (ASICs), field programmable gate arrays (FPGAs), a group of processing components, or other suitable electronic processing components. As such, the provider computing system 110 is configured to run a variety of application programs and store associated data in a database of the memory 116 (e.g., database 130).

The I/O circuit 120 is structured to receive communications from and provide communications to other computing devices, users, and the like associated with the provider computing system 110. The I/O circuit 120 is structured to exchange data, communications, instructions, and the like with an I/O device of the components of the system 100. In some embodiments, the I/O circuit 120 includes communication circuitry for facilitating the exchange of data, values, messages, and the like between the I/O device 120 and the components of the provider computing system 110. In some embodiments, the I/O circuit 120 includes machine-readable media for facilitating the exchange of information between the I/O circuit 120 and the components of the provider computing system 110. In some embodiments, the I/O circuit 120 includes any combination of hardware components, communication circuitry, and machine-readable media.

In some embodiments, the I/O circuit 120 may include a communication interface 122. The communication interface 122 may establish connections with other computing devices by way of the network 105. The communication interface 122 may include program logic that facilitates connection of the provider computing system 110 to the network 105. In some embodiments, the communication interface 122 may include any combination of a wireless network transceiver (e.g., a cellular modem, a Bluetooth transceiver, a Wi-Fi transceiver) and/or a wired network transceiver (e.g., an Ethernet transceiver). For example, the I/O circuit 120 may include an Ethernet device, such as an Ethernet card and machine-readable media, such as an Ethernet driver configured to facilitate connections with the network 105. In some embodiments, the communication interface 122 includes the hardware and machine-readable media sufficient to support communication over multiple channels of data communication. Further, in some embodiments, the communication interface 122 includes cryptography capabilities to establish a secure or relatively secure communication session in which data communicated over the session is encrypted.

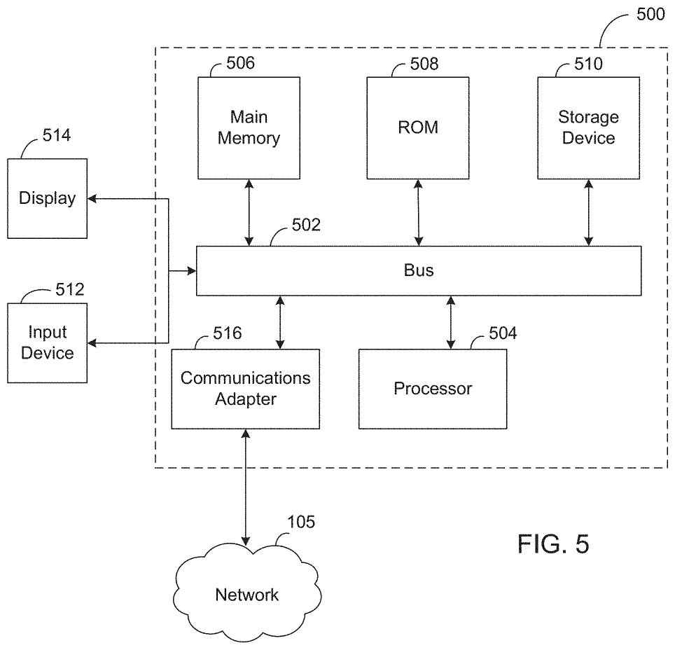

In some embodiments, the I/O circuit 120 includes suitable I/O ports and/or uses an interconnect bus (e.g., bus 502 in FIG. 5) for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the I/O circuit 120 may provide an interface for the user to interact with various applications and/or executables stored on the provider computing system 110. For example, the I/O circuit 120 may include a keyboard, a keypad, a mouse, joystick, a touch screen, a microphone, a biometric device, a virtual reality headset, smart glasses, and the like. As another example, I/O circuit 120, may include, but is not limited to, a television monitor, a computer monitor, a printer, a facsimile, a speaker, and so on.

The memory 116 may store a database 130, according to some embodiments. The database 130 may retrievably store data associated with the provider computing system 110 and/or any other component of the computing system 100. That is, the data may include information associated with each of the components of the computing system 100. For example, the data may include information about and/or received from the telematics device 140 and/or the user device 150. The data may be retrievable, viewable, and/or editable by the provider computing system 110 (e.g., by user input via the I/O circuit 120).

The database 130 may be configured to store one or more applications and/or executables to facilitate any of the operations described herein. In some arrangements, the applications and/or executables may be incorporated with an existing application in use by the provider computing system 110. In some arrangements, the applications and/or executables are separate software applications implemented on the provider computing system 110. The applications and/or executables may be downloaded by the provider computing system 110 prior to its usage, hard coded into the memory 116 of the processing circuit 112, or be a network-based or web-based interface application such that the provider computing system 110 may provide a web browser to access the application, which may be executed remotely from the provider computing system 110 (e.g., by a user device). Accordingly, the provider computing system 110 may include software and/or hardware capable of implementing a network-based or web-based application. For example, in some instances, the applications and/or executables include components written in HTML, XML, WML, SGML, PHP, CGI, and like languages. In the latter instance, a user (e.g., a provider employee) may log onto or access the web-based interface before usage of the applications and/or executables. In this regard, the applications and/or executables may be supported by a separate computing system including one or more servers, processors, network interfaces, and so on, that transmit applications for use to the provider computing system 110.

In the embodiment shown in FIG. 1A, the database 130 includes an item damage severity database 132 and a claims database 134.

The item damage severity database 132 is structured to store severity information, including actual severity information and/or predicted severity information. In some embodiments, the severity information may include item damage severity information. In some embodiments, the severity information may include metadata associated with a claim, a claim variable, a time period, a date, and/or other parameters related to the determined severity of item damage.

Item damage information can be received by parsing data from a claims data file or interface message and/or by parsing telematics data from a data file and/or interface message. According to an embodiment, the claims database 134 is structured to store claims information for a plurality of claims. The claims information includes a plurality of claim variables for each claim. As used herein, the term “claim variables” can include any data point that impacts the determination of item damage severity. The claim variables include but are not limited to: an indication of whether the claim involved tow removal, a coverage cost, an indication of whether a vehicle door or doors is/are openable after the accident, an indication of a fluid leak, an indication of an insured car body type, an indication of whether the claim was also reported to authorities, a damage score, a report year, an indication of prior damage to an insured item and/or an item associated with the insured item, a loss to report lag time, a location (e.g., country, state, region, county, city, etc.), an indication of natural disasters, emergencies, disease outbreaks, or other parameters associated with the location, a state highway study, a time (e.g., year, month, week, day, date, hour, etc.), an indication of whether the claim is from a no-fault state, state texting restrictions (e.g., phone usage restrictions), gross damage, an indication of whether a person was injured, an indication of liability, a claimant car cost, a FNOL report method, an expected severity (described in detail herein below), and/or other parameters related to the claim. In the embodiment shown in FIG. 1B, the claims database 134 may be stored by electronic storage other than the database 130. Accordingly, the computing system 100 may include a separate claims database 172 that is stored at a claims processing server 160.

According to various embodiments, the provider computing system 110 includes any combination of hardware and software structured to facilitate operations of the components of the computing system 100. For example, and as shown in FIG. 1, the provider computing system includes an item damage severity aggregation circuit 124 and an item damage severity modeling circuit 126 for determining percent severity impact for each of a plurality of claim variables. More generally, the provider computing system 110 may include any combination of hardware and software including specialized processing circuits, applications, executables, and the like for controlling, managing, or facilitating the operation of the other computing systems of the computing system 100 including the telematics device 140 and/or the user device 150. For example, the provider computing system 110 may include a telematics device interface circuit structured to receive and retrievably store data from a remote telematics device, such as a telematics device positioned on-board of an insured item.

In some embodiments, the item damage severity aggregation circuit 124 is structured to receive severity information. The severity information may be received from the user device 150, the item damage severity database 132, and/or another computing device communicatively coupled to the network 105. The severity information may include actual severity data related to one or more claims. For example, the severity information may include an actual severity value for a claim. As utilized herein, “actual severity data” refers to severity data that is fully known for a claim or set of claims. For example, severity data may not be fully known for a claim or set of claims until after the time period in which a loss occurred (e.g., when further item inspection, whether on-site or remote, is needed, when a further investigation related to the circumstances surrounding an accident is needed, or under similar circumstances which may affect the final payout amount and the corresponding item damage severity determination). Accordingly, “actual severity data” is severity data that is fully known when used by the systems and methods described herein, when reported, etc.

As briefly described above, the severity may be measured by a quantitative value, such as a severity score or a dollar amount. In an example embodiment, the severity data includes a quantitative value of severity for each claim of a plurality of claims. Additionally and/or alternatively the severity data includes a quantitative value for each claim variable of a plurality of claims. The item damage severity aggregation circuit 124 is structured to aggregate severity data and provide actual severity data to other components of the provider computing system 110, such as the item damage severity modeling circuit 126 and/or the item damage severity database 132. In some embodiments, the item damage severity aggregation circuit 124 is also structured to provide the claims data associated with the actual severity data to other components of the provider computing system 110.

The item damage severity modeling circuit 126 is structured to store computer-executable instructions embodying one or more machine learning models. The one or more machine learning models are configured to generate one or more statistical models of damage severity. The item damage severity modeling circuit 126 may be structured to train the one or more machine learning models based on the claims information and the severity information such that the one or more machine learning models outputs and/or determines a predicted severity. As used herein “predicted severity” is severity that is estimated or predicted, using one or more statistical methods, machine learning algorithms, and the like, by estimating the factors that are not fully known when damage is reported. For example, the one or more machine learning models may be trained using training data that includes claims data (e.g., stored at the claims database 134 or at the claims database 172) and actual severity data stored at the severity database 132. In some embodiments, the actual severity data may be provided by the item damage severity aggregation circuit 124. The one or more machine learning models are trained to generate predicted severity based on the training data. In some embodiments, the one or more machine learning models generate decision trees to output and/or determine predicted severity based on input claim data. For example, the item damage severity modeling circuit 126 may receive claim data and identify (e.g., parse) one or more claim variables from the received claim data. The item damage severity modeling circuit 126 may utilize the one or more trained machine learning models to determine and/or output the predicted severity. As briefly described above, the one or more machine learning models may include a machine learning explanatory model (e.g., SHAP or another suitable model). Accordingly, the item damage severity modeling circuit 126 may utilize the machine learning explanatory model with the one or more machine learning models to output and/or determine a base rate of expected severity and/or explainer values. For example, the machine learning explanatory model (e.g., SHAP or another suitable model) may identify the decisions made at the one or more decision trees and generate explainer values representing calculations performed at each decision juncture. The explainer values correspond to a claim variable of the claim data input into the one or more machine learning models. Specifically, the machine learning explanatory model generates explanatory values for each claim variable in the one or more decision trees. A sum of the explanatory values is equivalent to the output (e.g., the predicted severity). The base rate of severity is output and/or determined by the machine learning explanatory model by calculating an average actual severity of the training dataset.

In an example operational scenario, the item damage severity modeling circuit 126 receives claims information (e.g., from the claims database 134 or the claims database 172). The item damage severity modeling circuit 126 may run code and/or executables that define the one or more machine learning models. The code and/or executables may use parameters parsed from the claims data (e.g., claim variables) as inputs for the machine learning models. The code and/or executables may be embodied in the item damage severity modeling circuit 126, stored by the memory 116, stored by the database 130, and/or accessed from a remote computing device via the network 105 and/or the communication interface 122. The code and/or executables may be compiled at runtime or before execution (e.g., an .exe file). Accordingly, the item damage severity modeling circuit 126 may output and/or determine, using the one or more machine learning models including the machine learning explanatory model, a first set of explainer values for a first set of claims within a first time period (e.g., a target time period). The “explainer value” is a quantitative value associated with an input of the one or more machine learning models. As described above, the one or more machine learning models receive claims data including claim variables for each claim as input. The one or more machine learning models generates a predicted severity for each claim. Accordingly, the “explainer value” is a value associated with each claim variable for each claim that is equivalent to the partial predicted severity for each claim variable. The sum of all the explainer values for a claim is equal to the predicted severity for the claim. The explainer value may be positive (e.g., when the claim variable is predicted to increase the total severity), negative (e.g., when the claim variable is predicted to decrease the total severity), or zero (e.g., when the claim variable is predicted to have no impact on the total severity). The item damage severity modeling circuit 126 may output and/or determine, using the one or more machine learning models including the machine learning explanatory model, a second set of explainer values for a second set of claims within a second time period, where the first time period is after the second time period. The item damage severity modeling circuit 126 outputs and/or determines a total of explainer values for each claim variable. The item damage severity modeling circuit 126 then averages the explainer values for each claim variable. The item damage severity modeling circuit 126 then calculates a percent change in severity impact for each claim variable based on the average explainer value of the first time period, the average explainer value of the second time period, and an actual severity for the claims in the second time period. The item damage severity modeling circuit 126 may be structured to output all determined values, including the percent change in severity impact for each claim variable, as an output severity data packet. The item damage severity modeling circuit 126 may also be structured to generate a user interface that includes one or more graphical features depicting the output severity data packet.

As shown, the telematics device 140 includes a processing circuit 142, a sensor circuit 144 and an I/O circuit 146. The processing circuit 142 and the I/O circuit 146 may be substantially similar in structure and/or function as the processing circuit 112 and I/O circuit 120. For example, the processing circuit 142 may include a processor and memory similar to the processor 114 and memory 116, and the I/O circuit 120 may include a communication interface 148 that is similar to the communication interface 122. Accordingly, the telematics device 140 may communicatively couple to the network 105 via the communication interface 148. The telematics device 140 is structured to send telematics data to other computing devices via the network 105. The telematics data may be detected by telematics device 140. In some embodiments, the telematics device 140 may transmit the telematics data to the provider computing system 110. For example, the telematics device 140 may transmit the telematics data to the claims database 134 and/or to the item damage severity modeling circuit 126. The item damage severity modeling circuit 126 may be structured to automatically re-train the one or more machine learning models using the telematics data and/or to automatically output and/or determine a predicted severity based on the telematics data including one or more claims. In some embodiments, the telematics device 140 transmits the telematics data to the claims processing server 160 (FIG. 1B).

The sensor circuit 144 may include any combination of hardware and/or software for sensing telematics data. The hardware may include one or more sensors, such as an accelerometer, a positioning sensor (e.g., GPS), a vehicle interface sensor for interfacing with a computing system of a vehicle (e.g., an ECM), a motion sensor, and the like. In some embodiments, the sensor circuit 144 may communicatively couple to one or more external sensors via the I/O circuit 146. The software may include appropriate programs, executables, drivers, etc. for operating the one or more sensors and/or one or more external sensors. Accordingly, the telematics data may include data detected by the one or more sensors such as acceleration data, braking data, an indication of an impact, and/or other data detected by the one or more sensors. The telematics data may further include data for any of the claim variables described herein above. For example, the telematics data may include an indication of an accident, an indication of whether a door is open, an indication of acceleration before an accident, an indication of whether a vehicle was towed from an accident, etc. In some embodiments, the telematics device 140 may receive data from the user device 150, and the telematics data may include the data received from the user device 150. The data received from the user device 150 may include sensor data from a user device sensor, user data input by a user before or after an accident, and/or other data from the user device 150 associated with a claim.

The user device 150 includes a processing circuit 152 and an I/O circuit 156. The processing circuit 152 and the I/O circuit 156 may be substantially similar in structure and/or function as the processing circuit 112 and I/O circuit 120. For example, the processing circuit 152 may include a processor and memory similar to the processor 114 and memory 116, and the I/O circuit 120 may include a communication interface 158 that is similar to the communication interface 122. Accordingly, the user device 150 may communicatively couple to the network 105 via the communication interface 158. The user device 150 is structured to send and receive data to/from other computing devices via the network 105. The data may include claims data and/or severity data. For example, the user device 150 may be structured to collect claims data including values for one or more of the claim variables described above. The user device 150 may detect, by one or more user device sensors, the claims data and/or the claims data may be entered into the user device 150 by a user (e.g., a provider customer, a provider employee, a provider agent, etc.). The user device 150 may also receive the output severity data packet. The user device 150 may be configured to display a user interface depicting aspects of the output severity data packet. In some embodiments, the user interface is generated by the provider computing system 110 (e.g., the item damage severity modeling circuit 126), and displayed by the user device 150. In other embodiments, the user interface is generated and displayed by the user device 150 based on the output severity data packet.

Now referring to FIG. 1B, the computing system 100 is shown to further include a claims processing server 160. The claims processing server 160 includes a processing circuit 162, an I/O circuit 166, and a database 170. The processing circuit 162 and the I/O circuit 166 may be substantially similar in structure and/or function as the processing circuit 112 and I/O circuit 120. For example, the processing circuit 162 may include a processor and memory similar to the processor 114 and memory 116, and the I/O circuit 166 may include a communication interface 168 that is similar to the communication interface 122. Accordingly, the claims processing server 160 may communicatively couple to the network 105 via the communication interface 168. The database 170 may be substantially similar to the database 130. The database 170 may store a claims database 172 in addition to and/or alternatively to the claims database 134.

In the embodiment shown in FIG. 1B, the telematics device 140 and/or the user device 150 provide claims data to the claims processing server 160. The claims processing server 160 may store claims data including values for each claim variable of every claim. The claims processing server may provide the claims data to the provider computing system 110.

In some embodiments, the provider computing system 110 and the claims processing server 160 are the same computing device or devices such that the claims processing and item damage severity analysis are completed by the same device. In other embodiments, the provider computing system 110 and the claims processing server 160 are physically separate computing systems that are communicatively coupled by the network 105.

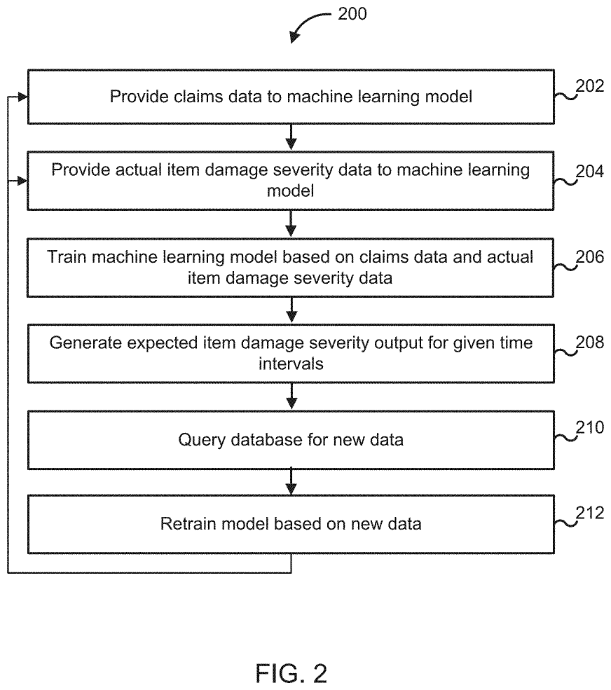

FIG. 2 is a flow diagram including computer-based operations for training a machine learning model. In some arrangements, one or more of the computing systems of the system 100 may be configured to perform a method 200. For example, the provider computing system 110 may be structured to perform the method 200, alone or in combination with other devices, such as the telematics device 140, the user device 150, and/or the claims processing server 160. In some embodiments, the method 200 may include user inputs from a user (e.g., a provider employee), one or more user devices (such as devices of provider employees), another computing device on the network 105, and the like.

In broad overview of the method 200, at step 202, the provider computing system 110 provides claims data to the machine learning model. At step 204, the provider computing system 110 provides actual item damage severity data to the machine learning models. At step 206, provider computing system 110 trains the machine learning model based on the claims data and the actual item damage severity data. At step 208, the provider computing system 110 generates an expected item damage severity output for given time intervals. At step 210, the provider computing system 110 queries a database for new data. At step 212 the machine learning model is re-trained based on the new data, and the method 200 repeats back to step 202 and/or step 204. In some arrangements, the method 200 may include more or fewer steps than as shown in FIG. 2.

Referring to the method 200 in more detail, at step 202, the provider computing system 110 provides claims data to the machine learning model. For example, the item damage severity modeling circuit 126 may receive the claims data from the claims database 134 and/or the claims database 172. The item damage severity modeling circuit 126 may also receive claims data directly from the telematics device 140 and/or the user device 150. At step 204, the provider computing system 110 provides actual item damage severity data to the machine learning models. For example, the item damage severity modeling circuit 126 may receive the actual item damage severity data from the item damage severity database 132.

At step 206, provider computing system 110 trains the machine learning model based on the claims data and the actual item damage severity data. The item damage severity modeling circuit 126 trains the machine learning model(s) to predict item damage severity based on an input including claims data. The claims data input may include values for one or more claim variables for each claim. The one or more machine learning models may be trained using claims data from within a given time period (e.g., one day, one week, one month, etc.). In an example embodiment, the one or more machine learning models are trained using claims data and actual severity data from a first time period. In an additional example embodiment, the one or more machine learning models are trained using a plurality of different configurations of the claims variables and a plurality of combinations of model parameters to output and/or determine which of the one or more machine learning models generates outputs with higher accuracy. The one or more machine learning models output and/or determine estimated severity data from the claims data and are trained to target the actual severity data. The one or more machine learning models may iteratively generate predicted severity data and self-correct until the predicted severity data is within a tolerance threshold of the actual severity data. The tolerance threshold may be a predetermined threshold (e.g., within 10%, within 5%, etc.). The one or more machine learning models may be re-trained or self-corrected on demand (e.g., by user input) and/or automatically in real-time (e.g., every second, every millisecond, every minute, etc.) and/or at regular intervals (e.g., every day, every week, every month, etc.).

At step 208, the provider computing system 110 generates an expected item damage severity output for given time intervals. The item damage severity modeling circuit 126 may generate, based on the trained machine learning models, an expected item damage severity output. The expected item damage severity output may be generated for a set of claims within a time period that does not have actual severity data.

At step 210, the provider computing system 110 queries a database for new data. The item damage severity modeling circuit 126 may query the database 130 and/or the database 170 for new claims data and/or new actual severity data. Advantageously, the process of retraining the machine learning model can be made fully automatic such that the item damage severity modeling circuit self-corrects as new actual severity data becomes available in order to improve the accuracy of future predictions. Accordingly, the query that obtains new claims data and/or new actual severity data may be automatically repeated in substantially real-time (e.g., every minute, every 5 minutes, every hour, etc.) or periodically (e.g., every day, every week, every month, etc.). At step 212 the machine learning model is re-trained based on the new claims data and/or new actual severity data, and the method 200 repeats back to step 202 and/or step 204. For example, when the item damage severity modeling circuit 126 receives new actual severity for a set of claims within a time period, the item damage severity modeling circuit 126 may re-train the one or more machine learning models based on the claims data and item damage severity data within the time period. The new data can be run, by the item damage severity modeling circuit 126, through the steps of the method 200 to re-train the machine learning model.

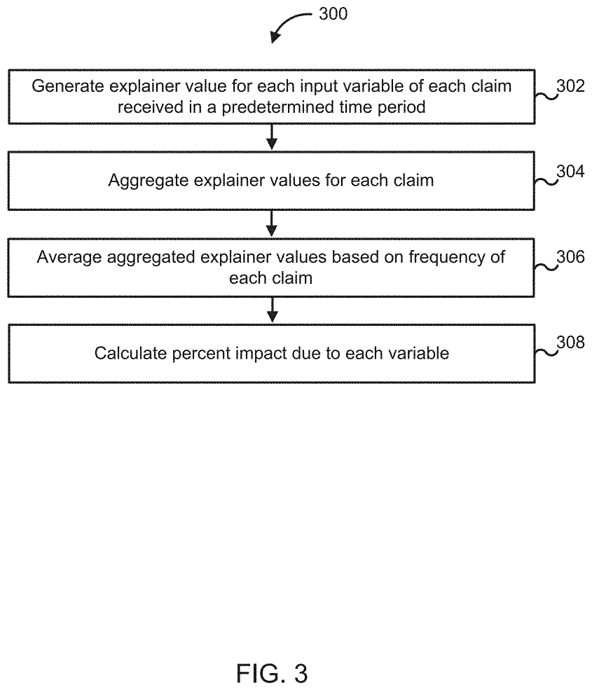

FIG. 3 is a flow diagram including computer-based operations for determining a multi-variable percent change in item damage severity. In some arrangements, one or more of the computing systems of the computing system 100 may be configured to perform the method 300. For example, the provider computing system 110 may be structured to perform the method 300, alone or in combination with other devices, such as the telematics device 140, the user device 150, and/or the claims processing server 160. In some embodiments, the method 300 may include user inputs from a user (e.g., a provider employee), one or more user devices (such as devices of provider employees), another computing device on the network 105, and the like.

In broad overview of method 300, at step 302, the provider computing system 110 generates an explainer value for each input variable of each claim received in a predetermined time period. At step 304, the provider computing system 110 aggregates the explainer values for each claim. At step 306, the provider computing system 110 averages the aggregated explainer values based on a frequency of each claim. At step 308, the provider computing system 110 calculates a percent impact due to each variable. In some arrangements, the method 300 may include more or fewer steps than as shown in FIG. 3.

Referring to the method 300 in more detail, at step 302, the provider computing system 110 generates an explainer value for each input variable of each claim received in a predetermined time period. The explainer values may be generated based on a relative impact each claim variable has on the total item damage severity. The explainer values may be generated using a machine learning explanatory model, such as SHAP. For example, the one or more machine learning models may generate one or more decision trees to arrive at an output. The provider computing system 110 and/or one or more components thereof may utilize the machine learning explanatory model with the one or more machine learning models. The machine learning explanatory model may identify the decisions made at the one or more decision trees and generate explanatory values representing calculations performed at each decision juncture. The explanatory values correspond to the claim variables of the claim data input into the one or more machine learning models. In the embodiments described herein, the one or more machine learning models generate decision trees to output and/or determine a predicted severity based on one or more claim variable inputs. The machine learning explanatory model generates explanatory values for each claim variable in the one or more decision trees, and a sum of the explanatory values is equivalent to the output (e.g., the predicted severity). At step 304, the provider computing system 110 aggregates the explainer values for each claim. The explainer values may be aggregated for a set of claims. For example, the explainer value for one type of claim variable is added up resulting in a total item damage severity for a single claim variable across the set of claims. In some embodiments, the provider computing system 110 sums explainer values for one or more line IDs to the claim level. For example, a single claim may have one or more line IDs and/or the claim may include more than one insured item. Accordingly, one or more of the line IDs may be related to a first insured item, a second insured item, and so on. The provider computing system 110 may sum the explainer values for each of the one or more line IDs of a claim. Accordingly, when the claim is a multi-coverage claim (e.g., a claim having more than one line ID and/or a claim related to more than one insured item) the line IDs are aggregated such that each claim is associated with a single, aggregated value. This process may be repeated for some or all of the claim variables. In various embodiments, the set of claims can be aggregated according to the FNOL date, loss date, insured item type, make and/or model, geographical location of loss (e.g., GPS coordinates, zip code, etc.), or any suitable combination thereof. In an example embodiment, the set of claims is aggregated according to a claim identifier (e.g., a claim number, a claim ID, etc.).

At step 306, the provider computing system 110 averages the aggregated explainer values. The average is calculated by multiplying a relative frequency (e.g., percent occurrence of each claim variable in the claims within the predetermined time period) of a claim variable by the corresponding aggregated explainer value (e.g., for the same claim variable). That is, an aggregated explainer value for a first claim variable (X₁) is multiplied by the percent occurrence of that claim variable (Y₁) within the predetermined time period (e.g., within a week, a month, a quarter, a year, etc.). For example, a first claim variable may be a type of vehicle where X₁ is an aggregated explainer value for the vehicle type and where Y₁ is a percentage of claims that include the vehicle type. The average explainer value is calculated as the product of X₁ and Y₁. In some embodiments, the average explainer value may be calculated for each claim variable of a plurality of claims within the predetermined time period. In some embodiments, the average explainer value may be calculated for at least one claim variable for the plurality of claims within the predetermined time period.

At step 308, the provider computing system 110 calculates a percent impact due to each variable. The percent impact due to each claim variable is calculated as a percent change in average explainer value for each claim variable between a first time period and a second time period. The first time period may be a target time period. The second time period may be a time period before the first time period (e.g., one month before, one year before, etc.). First, the item damage severity modeling circuit 126 sums the average explainer values for the first time period and sums the average explainer values for the second time period. The result is a predicted item damage severity for the first time period (S1) and a predicted item damage severity for the second time period (S2). That is, according to an embodiment, the predicted item damage severity for the first time period (S1) is equal to the sum of each explainer value (Xᵢ₁) for each claim in the first time period multiplied by the percent occurrence of that claim variable (Yᵢ₁) within the first time period. Similarly, the predicted item damage severity for the second time period (S2) is equal to the sum of each explainer value (Xᵢ₂) for each claim in the second time period multiplied by the percent occurrence of that claim variable (Yᵢ₂) within the second time period.

The percent impact due to each claim variable is calculated by subtracting the average explainer value for a claim variable for the second time period (E2) from the average explainer value for that same claim variable for the first time period (E1) and dividing the result by the predicted item damage severity for the second time period (S2). The result is a percent impact due to a single claim variable based on the predicted severity (I1). Accordingly, this process may be repeated for each claim variable of the claims in the first time period. The item damage severity modeling circuit 126 may correct the percent impact due to each claim variable to be based on the actual severity of the second time period (I2). An example equation (1) is shown below.

I1=(E1−E2)/S2 (1)

The provider computing system 110 may correct the percent impact because, in some embodiments, there may be a difference between the predicted severity in a time period (e.g., the first time period) and the actual severity in the same time period. The difference may be due to inaccuracies of the machine learning model(s) (including machine learning explanatory model(s)) used to generate the explainer values, predicted severity, etc. To correct the results, the item damage severity modeling circuit 126 calculates a percent change between the predicted severity of the first time period (S1) and the predicted severity of the second time period (S2) resulting in a predicted severity percent change (P1). The item damage severity modeling circuit 126 then calculates a percent change between the actual severity of the second time period (A2) and the predicted severity of the first time period (S1) resulting in an actual severity percent change (P2). The item damage severity modeling circuit 126 calculates the percent impact due to each claim variable based on the actual severity of the second time period (I2) by multiplying the percent impact due to each claim variable based on the predicted severity (I1) by the actual severity percent change (P2) and dividing by the predicted severity percent change (P1). The result is a percent impact due to each claim variable based on the actual severity of the second time period (I2), and may be output as the output severity data packet. An example equation (2) is shown below.

I2=I1(P2/P1) (2)

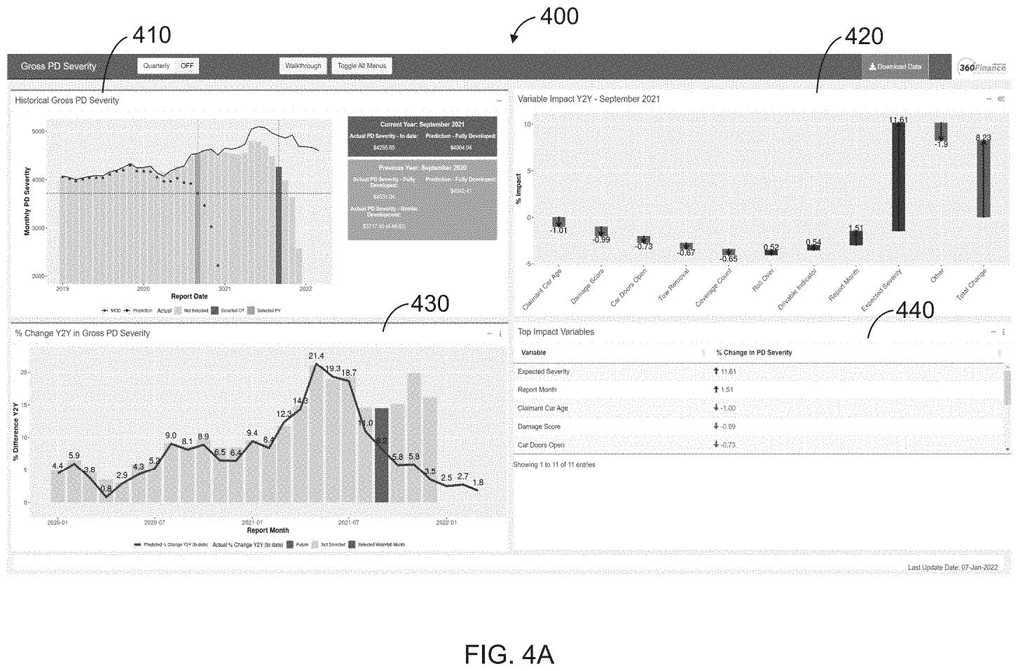

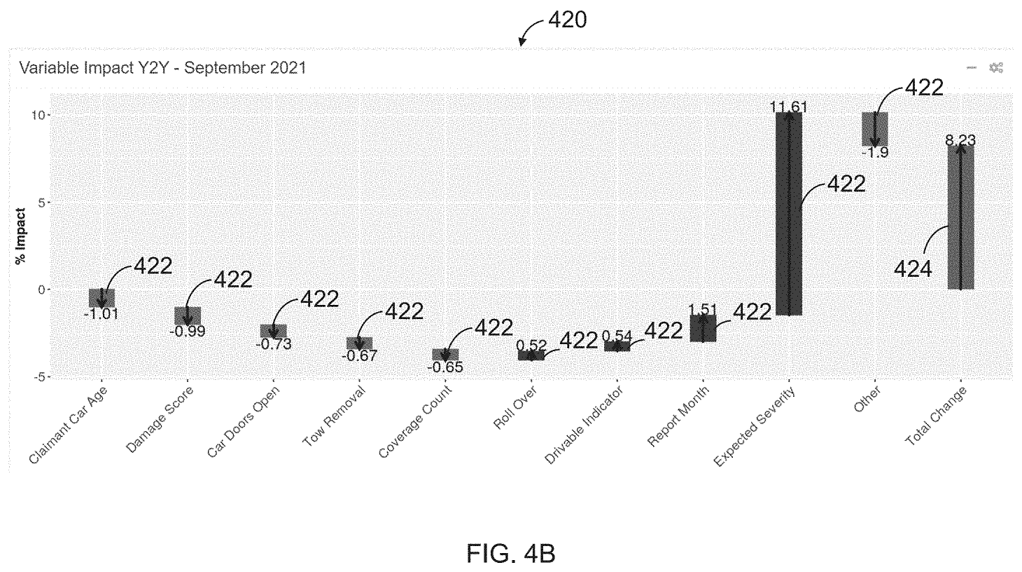

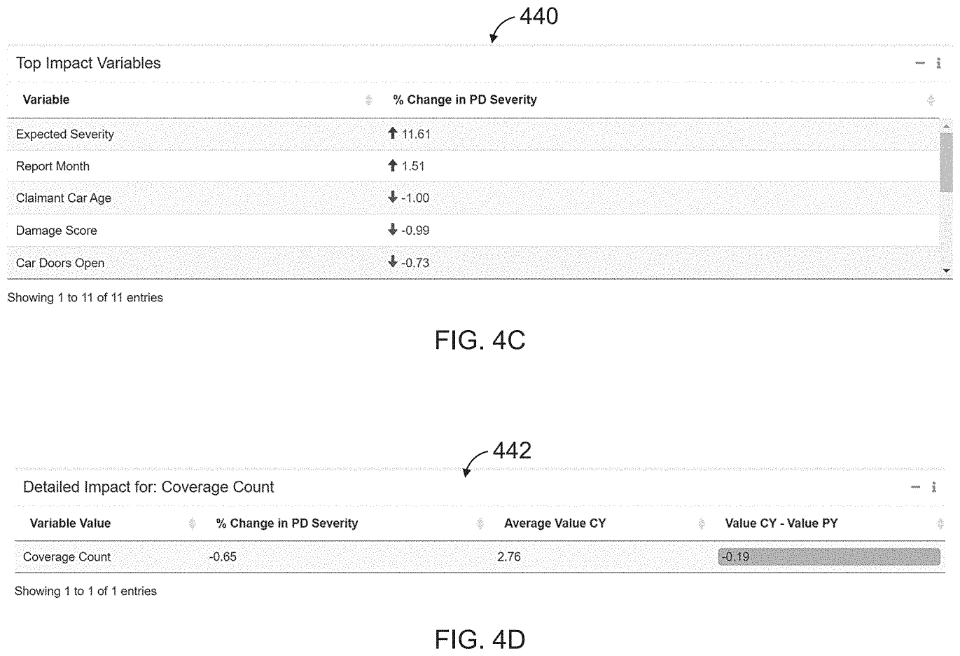

FIG. 4A is an illustration showing various aspects of a user interface 400, according to an example embodiment. FIGS. 4B-4D are illustrations showing various aspects of the user interface 400 of FIG. 4A. As briefly described above, the user interface 400 may be generated and displayed by one or more of the computing systems of the system 100. For example, the user interface 400 may be generated by the provider computing system 110 and/or the user device 150. The user interface 400 may be displayed by a display of the provider computing system 110 and/or a display of the user device 150.

The user interface 400 includes one or more graphical representations of the data described herein above, such as the output severity data packet, the claims data, the severity data, etc. The first graphical feature 410 may include a graph comparing actual severity and predicted severity of a predetermined time period (e.g., the first time period). The predicted severity is calculated (e.g., by the provider computing system 110 and/or one or more components thereof) by summing the predicted severities for each line ID to the claim level (to account for claims having more than one line ID and/or more than one insured item) and then averaging the sum over a predetermined time period (e.g., the first time period).

The third graphical feature 430 may include a percent change in severity between the first time period and the second time period for a series of time periods. For example, the third graphical feature may include a percent change in severity between months of two years, such as a percent change between January of a first year and January of a second year. The graph may show multiple months in succession to show the change in percent change in severity over time. As shown, the third graphical feature 430 may include an actual percent change in severity between the first time period and the second time period (shown by the line graph) and a predicted percent change in severity between the first time period and the second time period (shown by the bar graph). Accordingly, the third graphical feature 430 visually represents a difference between the actual percent change in severity between the first time period and the second time period and the predicted percent change in severity between the first time period and the second time period.

The second graphical feature 420 may include a waterfall graph showing the percent impact due to each claim variable for each claim variable. Each percent impact is a part of the total change in severity between two predetermined time periods (e.g., the percent change from the first time period compared to the second time period). The second graphical feature may include one or more graphical features 422 representing each claim variable. The one or more graphical features 422 may be color coded to denote a positive or negative value. The one or more graphical features 422 may be ordered by value (e.g., from largest to smallest). The one or more graphical features 422 may be filtered automatically, by the provider computing system 110 (e.g., by the item damage severity modeling circuit 126), such that only percent impacts that are greater in absolute value compared to a threshold value are displayed. In some embodiments and as shown in FIG. 4B, the second graphical feature 420 may include an “other” graphical feature that aggregates all the percent change in severity values that were filtered out into a separate category that is displayed separately from the other values. In some embodiments and as shown in FIG. 4B, the second graphical feature may include a “total” graphical feature that aggregates all the percent impacts for each claim variable representing a total percent impact change.

The fourth graphical feature 440 includes a detailed list of claims data, item damage severity data, and/or percent impact data of the claim variables of the second graphical feature 420. For example, the fourth graphical feature 440 may display, by default, a list of claim variables and the percent impact for each claim variable, as shown in FIG. 4C. The list of claim variables may be filtered automatically, by the provider computing system 110 (e.g., by the item damage severity modeling circuit 126), such that only percent impacts that are greater in absolute value compared to a threshold value are displayed. Claim variables having percent impacts that are less than the threshold value are grouped into an “other” category. The threshold may be a predetermined threshold that may be adjusted by a user (e.g., via a user input). The fourth graphical feature 440 may also include a “total” category that aggregates all the percent impacts for each claim variable and displays a total percent impact change. In an example embodiment, the fourth graphical feature 440 displays a list of claim variables (including the “other” category and/or the “total” category) that is displayed in the second graphical feature 420. When one or more of the graphical features 422 is selected by a user (e.g., by input through the I/O circuit 120), the fourth graphical feature 440 may display a detailed graphical feature 442 that includes a list of values for the selected graphical feature 422, as shown in FIG. 4D. For example, if a user selects a first graphical feature 422, the fourth graphical feature 440 may display the corresponding claim variable, percent change in severity value, an indication of whether the percent change in severity is positive or negative (e.g., by a color or arrow), an average value for the claim variable for the first time period, a change in average value for the claim variable between the first time period and the second time period, and/or other values associated with the corresponding claim variable.

In an example embodiment, a user may select a first claim variable from the claim variables shown in the second graphical feature 420. As shown in FIG. 4D, the selected variable is “Coverage Count” (e.g., a total number of coverages associated with a claim). The fourth graphical feature 440 may display a detailed graphical feature 442 that includes an average value of the claim variable (determined by averaging the claim variable values for all claims in a predetermined time period). In some embodiments, the claim variable values are numerical and the average is calculated and displayed. In other embodiments, the claim variable values are qualitative (e.g., “yes”, “no”, “unknown”, etc.) and the detailed graphical feature 442 includes a frequency percentage instead of the average. For example, the user may select a second claim variable, such as a “tow removal” variable. The detailed graphical feature 442 may display a frequency of occurrences of “tow removal” instead of an average value. For example, the detailed graphical feature 442 may display a percent of claims in the predetermined time period that have each level of the categorical variable selected (e.g. the % of vehicles in the predetermined time period that had “Yes” for “Tow Removal”).

The result is an improved user interface that advantageously automatically sorts graphical features representing percent impact in descending order, filters the percent change in severity values based on a threshold such that only the largest in magnitude are shown (e.g., such that a user can easily read the graph and determine the most impactful claim variables), and is selectable by a user to view additional data on the user interface.

FIG. 5 is a component diagram of an example computing system suitable for use in the various embodiments described herein. For example, the computing system 500 may implement an example provider computing system 110, the telematics device 140, the user device 150, and/or various other example systems and devices described in the present disclosure.

The computing system 500 includes a bus 502 or other communication component for communicating information and a processor 504 coupled to the bus 502 for processing information. The computing system 500 also includes main memory 506, such as a random access memory (RAM) or other dynamic storage device, coupled to the bus 502 for storing information, and instructions to be executed by the processor 504. Main memory 506 can also be used for storing position information, temporary variables, or other intermediate information during execution of instructions by the processor 504. The computing system 500 may further include a read only memory (ROM) 508 or other static storage device coupled to the bus 502 for storing static information and instructions for the processor 504. A storage device 510, such as a solid state device, magnetic disk or optical disk, is coupled to the bus 502 for persistently storing information and instructions.

The computing system 500 may be coupled via the bus 502 to a display 514, such as a liquid crystal display, or active matrix display, for displaying information to a user. An input device 512, such as a keyboard including alphanumeric and other keys, may be coupled to the bus 502 for communicating information, and command selections to the processor 504. In another embodiment, the input device 512 has a touch screen display. The input device 512 can include any type of biometric sensor, a cursor control, such as a mouse, a trackball, or cursor direction keys, for communicating direction information and command selections to the processor 504 and for controlling cursor movement on the display 514.

In some embodiments, the computing system 500 may include a communications adapter 516, such as a networking adapter. Communications adapter 516 may be coupled to bus 502 and may be configured to enable communications with a computing or communications network 105 and/or other computing systems. In various illustrative embodiments, any type of networking configuration may be achieved using communications adapter 516, such as wired (e.g., via Ethernet), wireless (e.g., via Wi-Fi, Bluetooth), satellite (e.g., via GPS) pre-configured, ad-hoc, LAN, WAN, and the like.

According to various embodiments, the processes that effectuate illustrative embodiments that are described herein can be achieved by the computing system 500 in response to the processor 504 executing an arrangement of instructions contained in main memory 506. Such instructions can be read into main memory 506 from another computer-readable medium, such as the storage device 510. Execution of the arrangement of instructions contained in main memory 506 causes the computing system 500 to perform the illustrative processes described herein. One or more processors in a multi-processing arrangement may also be employed to execute the instructions contained in main memory 506. In alternative embodiments, hard-wired circuitry may be used in place of or in combination with software instructions to implement illustrative embodiments. Thus, embodiments are not limited to any specific combination of hardware circuitry and software.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” (e.g., “engine”) may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server, such as a cloud based server). To that end, a “circuit” as described herein may include components that are distributed across one or more locations.

An example system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory, such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A provider computing system comprising:
a communication interface structured to communicatively couple the provider computing system to a network;
a claims database storing claims information for a plurality of claims, the claims information comprising a plurality of claim variables;
an item damage severity database storing severity information;
an item damage severity modeling circuit storing computer-executable instructions embodying one or more machine learning models;
at least one processor; and
memory storing instructions that, when executed by the at least one processor, cause the at least one processor to:
receive a first claim dataset corresponding to a first time period;
parse a first plurality of variables from the first claim dataset;
receive a second claim dataset corresponding to a second time period before the first time period;
parse a second plurality of variables from the second claim dataset;
cause, by the item damage severity modeling circuit, the one or more machine learning models to parse a first plurality of explainer values from the first claim dataset and a second plurality of explainer values from the second claim dataset;
determine a first plurality of average explainer values for each of the first plurality of explainer values and a second plurality of average explainer values for each of the second plurality of explainer values;
determine percent impact values, wherein each of the percent impact values correspond to a first claim variable of the first plurality of variables and a second claim variable of the second plurality of variables, and wherein the first claim variable corresponds to the second claim variable;
generate and render, via a display of a computing device, a damage severity user interface comprising one or more selectable features, the one or more selectable features each representing one of the percent impact values; and
filter and sort the one or more selectable features based on the percent impact values and a predetermined impact threshold such that the one or more selectable features representing the percent impact values that are above the predetermined impact threshold are ordered in descending order.

2. The provider computing system of claim 1, wherein the claims database is structured to communicatively couple to a telematics device via the network, wherein the telematics device is associated with an insured item.

3. The provider computing system of claim 2, wherein the telematics device is structured to detect, by one or more sensors, one or more impact parameter values associated with the insured item; and
wherein the claims information comprises the one or more impact parameter values provided by the telematics device.

4. The provider computing system of claim 1, wherein the instructions further cause the at least one processor to train, by the item damage severity modeling circuit, the one or more machine learning models based on a first subset of the claims information and a first subset of the severity information such that the one or more machine learning models outputs a predicted severity based on an input claim dataset, wherein the first subset of claims information corresponds to a third time period.

5. The provider computing system of claim 4, wherein the third time period is at least partially before the second time period.

6. The provider computing system of claim 4, wherein determining a first percent impact value of the percent impact values comprises:
determining a difference between a first explainer value and a second explainer value, wherein the first explainer value is associated with the first claim variable and the second explainer value is associated with the second claim variable; and
dividing the difference by the predicted severity corresponding to the first claim variable within the second time period.

7. The provider computing system of claim 6, wherein the instructions further cause the at least one processor to:
generate, by an item damage severity aggregation circuit of the provider computing system, a first actual severity value for each of the claim variables within the second time period;
determine, by the item damage severity modeling circuit, a first percent change between the first plurality of average explainer values and the second plurality of average explainer values;
determine, by the item damage severity modeling circuit, a second percent change between the first plurality of average explainer values and the first actual severity value; and
correct, by the item damage severity modeling circuit, the first percent impact value by multiplying the first percent impact value by the second percent change divided by the first percent change.

8. The provider computing system of claim 7, wherein the severity user interface is structured to display, on the display and responsive to a first selectable feature of the one or more selectable features being selected, a detailed list of impact data associated with the first percent impact value, wherein the first selectable feature is associated with the first percent impact value.

9. A method comprising:
communicatively coupling, by a communication interface, a provider computing system to a network;
storing, by a claims database, claims information for a plurality of claims, the claims information comprising a plurality of claim variables;
storing, by an item damage severity database, severity information;
storing, by an item damage severity modeling circuit, computer-executable instructions embodying one or more machine learning models;
receiving a first claim dataset corresponding to a first time period;
parsing a first plurality of variables from the first claim dataset;
receiving a second claim dataset corresponding to a second time period before the first time period;
parsing a second plurality of variables from the second claim dataset;
causing, by an item damage severity modeling circuit of the provider computing system, the one or more machine learning models to parse a first plurality of explainer values from the first claim dataset and a second plurality of explainer values from the second claim dataset;
determining a first plurality of average explainer values for each of the first plurality of explainer values and a second plurality of average explainer values for each of the second plurality of explainer values;
determining percent impact values, wherein each of the percent impact values correspond to a first claim variable of the first plurality of variables and a second claim variable of the second plurality of variables, and wherein the first claim variable corresponds to the second claim variable;
generating and rendering, via a display of a computing device, a damage severity user interface comprising one or more selectable features, the one or more selectable features each representing one of the percent impact values; and
filtering and sorting the one or more selectable features based on the percent impact values and a predetermined impact threshold such that the one or more selectable features representing the percent impact values that are above the predetermined impact threshold are ordered from left to right in descending order.

10. The method of claim 9, further comprising:
communicatively coupling, by the communication interface, the claims database to a telematics device via the network, wherein the telematics device is associated with an insured item;
detecting, by one or more sensors of the telematics device, one or more impact parameter values associated with the insured item; and
receiving, by the claims database and via the communication interface, the claims information, the claims information comprising the one or more impact parameter values provided by the telematics device.

11. The method of claim 9, further comprising training, by the item damage severity modeling circuit, the one or more machine learning models based on a first subset of the claims information and a first subset of the severity information such that the one or more machine learning models outputs a predicted severity based on an input claim dataset, wherein the first subset of claims information corresponds to a third time period.

12. The method of claim 11, wherein the third time period is at least partially before the second time period.

13. The method of claim 11, wherein determining a first percent impact value of the percent impact values comprises:
determining a difference between a first explainer value and a second explainer value, wherein the first explainer value is associated with the first claim variable and the second explainer value is associated with the second claim variable; and
dividing the difference by the predicted severity corresponding to the first claim variable within the second time period.

14. The provider computing system of claim 13, wherein the instructions further cause the at least one processor to:
generate, by an item damage severity aggregation circuit of the provider computing system, a first actual severity value for each of the claim variables within the second time period;
determine, by the item damage severity modeling circuit, a first percent change between the first plurality of average explainer values and the second plurality of average explainer values;
determine, by the item damage severity modeling circuit, a second percent change between the first plurality of average explainer values and the first actual severity value; and
correct, by the item damage severity modeling circuit, the first percent impact value by multiplying the first percent impact value by the second percent change divided by the first percent change.

15. The provider computing system of claim 15, wherein the severity user interface is structured to display, on the display and responsive to a first selectable feature of the one or more selectable features being selected, a detailed list of impact data associated with the first percent impact value, wherein the first selectable feature is associated with the first percent impact value.

16. Non-transitory computer readable media having computer executable instructions embodied therein that, when executed by at least one processor of a computing system, cause the computing system to perform operations for generating multi-variable severity values, the operations comprising:
communicatively couple, by a communication interface, to a network;
store, by a claims database, claims information for a plurality of claims, the claims information comprising a plurality of claim variables;
store, by an item damage severity database, severity information;
store, by an item damage severity modeling circuit, computer-executable instructions embodying one or more machine learning models
receive a first claim dataset corresponding to a first time period;
parse a first plurality of variables from the first claim dataset;
receive a second claim dataset corresponding to a second time period before the first time period;
parse a second plurality of variables from the second claim dataset;
cause the one or more machine learning models to parse a first plurality of explainer values from the first claim dataset and a second plurality of explainer values from the second claim dataset;
determine a first plurality of average explainer values for each of the first plurality of explainer values and a second plurality of average explainer values for each of the second plurality of explainer values;
determine percent impact values, wherein each of the percent impact values correspond to a first claim variable of the first plurality of variables and a second claim variable of the second plurality of variables, and wherein the first claim variable corresponds to the second claim variable;
generate and render, via a display of a computing device, a damage severity user interface comprising one or more selectable features, the one or more selectable features each representing one of the percent impact values; and
filter and sort the one or more selectable features based on the percent impact values and a predetermined impact threshold such that the one or more selectable features representing the percent impact values that are above the predetermined impact threshold are ordered from left to right in descending order.

17. The media of claim 16, wherein the operations further comprise:
communicatively couple, by the communication interface, the claims database to a telematics device via the network, wherein the telematics device is associated with an insured item;
detect, by one or more sensors of the telematics device, one or more impact parameter values associated with the insured item; and
receive, by the claims database and via the communication interface, the claims information, the claims information comprising the one or more impact parameter values provided by the telematics device.

18. The media of claim 16, wherein the operations further comprise:
train, by the item damage severity modeling circuit, the one or more machine learning models based on a first subset of the claims information and a first subset of the severity information such that the one or more machine learning models outputs a predicted severity based on an input claim dataset, wherein the first subset of claims information corresponds to a third time period, and wherein the third time period is at least partially before the second time period.

19. The media of claim 18, wherein determining a first percent impact value of the percent impact values comprises:
determining a difference between a first explainer value and a second explainer value, wherein the first explainer value is associated with the first claim variable and the second explainer value is associated with the second claim variable; and
dividing the difference by the predicted severity corresponding to the first claim variable within the second time period.

20. The media of claim 19, wherein the operations further comprise:
generate, by an item damage severity aggregation circuit of the provider computing system, a first actual severity value for each of the claim variables within the second time period;
determine, by the item damage severity modeling circuit, a first percent change between the first plurality of average explainer values and the second plurality of average explainer values;
determine, by the item damage severity modeling circuit, a second percent change between the first plurality of average explainer values and the first actual severity value; and
correct, by the item damage severity modeling circuit, the first percent impact value by multiplying the first percent impact value by the second percent change divided by the first percent change.
